(19) United States
(12) Patent Application Publication
(10) Pub. No.: US 2004/0130479 A1
(43) Pub. Date: Jul. 8, 2004

(54) Robust data fusion procedure of a multi-digital surveillance information

(76) Inventors: Chen-Jui Lo, Taipei (TW); Chieh Wu, Taipei (TW); Sy-Kang Shen, Taipei (TW)

Correspondence Address: JOHNSON & ASSOCIATES PC, 14625 BALTIMORE AVENUE #282, LAUREL, MD, 20707, US

(21) Appl. No.: 10/335,129

(22) Filed: Jan. 2, 2003

(51) Int. Cl. G01S 13/93

(52) U.S. Cl. 342/29; 342/36; 342/37

(57) ABSTRACT

This invention relates to a robust data fusion procedure of multi-digital surveillance information mounted on an aircraft per se capable of receiving surveillance information of other aircrafts, including traffic information service (TIS), traffic alert and collision avoidance system (TCAS) and automatic dependant surveillance broadcasting (ADSB). The data fusing procedure of the multi-digital surveillance information of this invention is capable of applying data fusion module to provide an effective surveillance data fusion procedure for fusing the data produced by surveillance source (ADSB, TCAS and TIS). The traffic information of the aircraft per se is provided by GNSS while outputting the status information of other aircrafts in the surrounding airspace to the cockpit display traffic information (CDTI) system to enhance airborne security.

### BACKGROUND OF THE INVENTION

1. Field of the Invention

The present invention relates to robust data fusion procedure of multi-digital surveillance information. Specifically, the present invention relates to the application of a data fusion module capable of providing an effective surveillance data fusion procedure for fusing data provided by surveillance source such as (ADSB, TCAS and TIS); and the traffic information of the aircraft per se provided by GNSS while outputting the status information of other aircrafts in the surrounding airspace to the cockpit display of traffic information (CDTI) system.

2. Related Prior Art

Conventional air traffic security assurance relies on air traffic control (ATC) and air traffic service system (ATS) to provide airborne weather, schedule delay, relevant airport information to prevent collisions between aircrafts, and to prevent terrain obstacles and keep airplanes at appropriate distance separation and maintain smooth airborne traffic.

In an attempt to apply new technology in developing more secure airborne management system, a task force, SC 186 WG4 under the RTCA organization in 1999, disclosed in a document entitled “Airborne Surveillance and Separation Assurance Processing (ASSAP) MOPS DRAFT 0.6” that aircrafts are capable of receiving multiple search information, such as ADS-B traffic collision alert and avoidance system (TCAS). The document suggested that by using the procedure of ASSAP to input real-time processed data into the cockpit display of traffic information (CDTI) system, pilots and crews may become aware of the necessary traffic information in the surrounding airspace and would therefore take the necessary measures to keep appropriate distance separation with neighboring aircrafts to ensure airborne security.

However, task force SC186WG4 of RTCA only defined in the documents of ASSAP MOPS DRAFT 0.6 in 1999 the functions required in the procedure of ASSAP without any feasible instructions or methods on how to carry out the procedures. There are several difficulties with the ASSAP MOPS DRAFT 0.6 suggestions.

First, as stated earlier, there are no feasible measure or regulation disclosed in all the modules of the ASSAP for carrying out the procedure. Second, the surveillance equipments rigged on the aircrafts are not consistent with one another. Aircraft can only receive information from another aircraft rigged with identical equipment, therefore, under such circumstance, the aircraft per se is unable to monitor status information of all other aircrafts in the airspace.

### SUMMARY OF THE INVENTION

An object of the present invention is to provide a robust data fusion procedure of multi-digital surveillance information to solve the problems associated with related prior arts and enhance airborne security.

Another object of the present invention is that the aircraft per se rigged with the equipments may receive surveillance information such as (ADSB, TCAS and TIS) outputted by other aircrafts, and the data fusion module is applied to provide an effective surveillance data fusion procedure for fusing the data provided from surveillance source (ADSB, TCAS and TIS) and the traffic information, provided by GNSS, of the aircraft per se.

Further, another object of this invention is to output the status information of other aircrafts in the surrounding airspace to the cockpit display of the traffic information (CDTI) system to enhance airborne security.

Still further, another object of the present invention is to produce information for each aircraft based on the data acquired by each sensor of the aircraft per se and compare and sort the information of each aircraft based on the data of each sensor, and then fused to generate a correct and unique aircraft information.

Because there is no unified regulation for all nations with respect to the surveillance data fusion procedure, an essential object of the present invention is to provide an effective unified procedure for fusing data provided by surveillance source and data from the traffic information, provided by GNSS, of the aircraft per se; and to provide a top down compatible and precision aircraft information display mechanism including ADSB-TCAS-TIS, so as to minimize misunderstanding of status information of other aircrafts in surrounding airspace by pilots and navigators, thereby enhancing airborne security.

These and other features and advantages of the various aspects of the present invention will become more apparent upon reading the following description of a preferred exemplified embodiment of the invention and upon reference to the accompanying drawings.

### BRIEF DESCRIPTION OF DRAWINGS

FIG. 1 describes a flow chart of the robust data fusion procedure of multi-digital surveillance information; and the fusing of ADS-B, TCAS and TIS.

FIG. 2 describes a flow chart fusing ADS-B, and TIS.

FIG. 3 describes a flow chart fusing ADS-B, and TCAS.

FIG. 4 describes a flow chart fusing TCAS and TIS.

FIG. 5 describes a flow chart fusing ADS-B, TIS and TCAS.

### DETAILED DESCRIPTION AND PREFERRED EMBODIMENTS

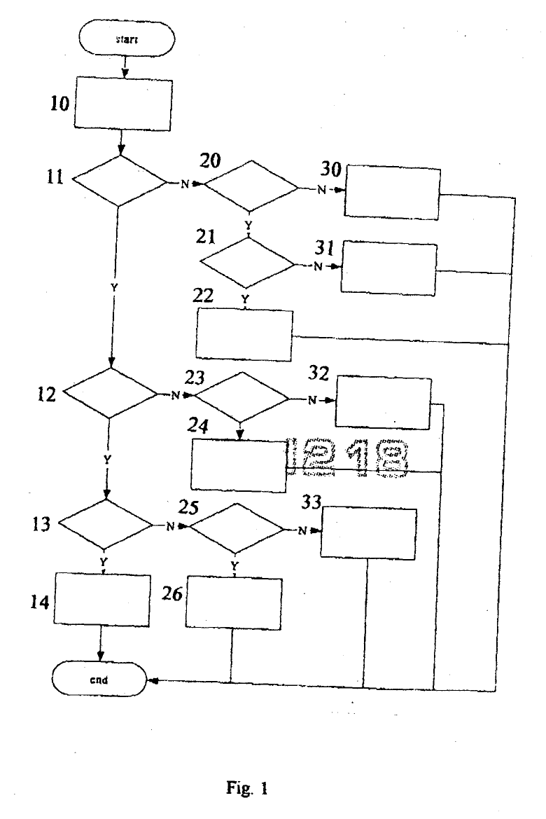

The present invention relates to a robust data fusion procedure of multi-digital surveillance information mounted on an aircraft per se and capable of receiving surveillance information from other aircrafts, including traffic information service (TIS), traffic alert and collision avoidance system (TCAS) and automatic dependant surveillance broadcasting (ADSB). The data fusing procedure of this invention is capable of applying data fusion module to provide an effective surveillance data fusion procedure for fusing the data provided by surveillance source (ADSB, TCAS and TIS); and the traffic information, provided by GNSS, of the aircraft per se while outputting the status information of other aircrafts in the surrounding airspace to the cockpit display traffic information (CDTI) system to enhance airborne security. The information fusion procedure is shown in FIG. 1 and is categorized as several combinations. First, if there is only one kind of data, directly produce aircraft information based on the data surveillance source. Second, if there are two kinds of data, the provide combinations are described as follows:

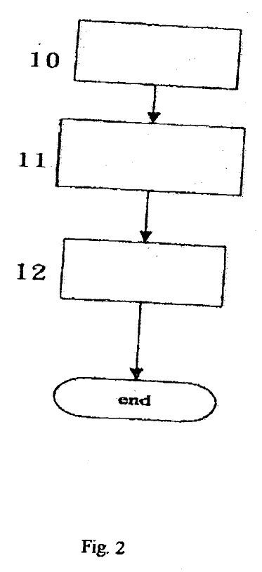

ADS-B and TIS: to generate aircraft information mainly based on ADS-B if the altitude of aircraft is low or the aircrafts' relative distance exceeds 5 nmi, as shown in FIG. 2.

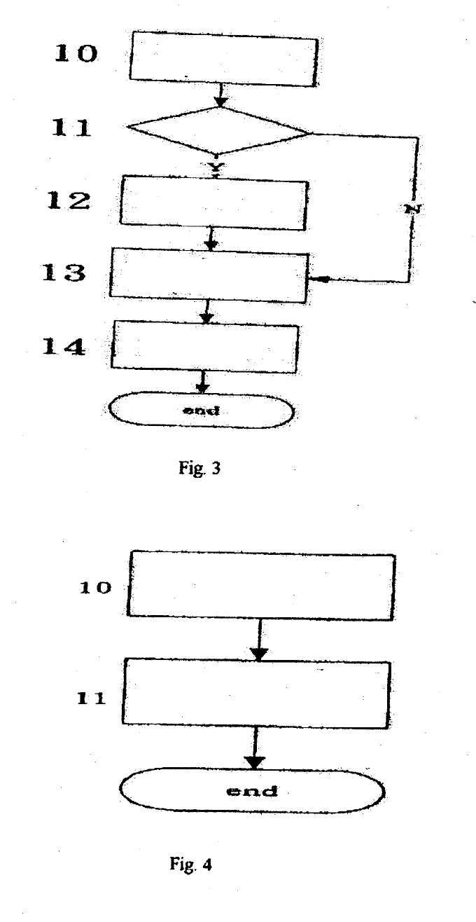

b. ADS-B and TCAS: to generate aircraft information mainly based on ADS-B; when TCAS generates RA/TA the relative information of the aircraft warning is mainly based on TCAS, as described in FIG. 3, and

c. TCAS and TIS: to generate aircraft information mainly based on TCAS, as shown in FIG. 4.

The following theories, conditions and situations, though not limited, are essential for operating the robust data fusion procedure of the multi-digital surveillance information of this invention: (1) The effective surveillance distance of ADS-B is 120 nmi, TCAS is 30 nmi and TIS is 5 nmi; (2) ADS-B outputed information provides precise information of geographic location (longitude and latitude) which the other surveillance equipments do not supply; (3) TCAS contains TA/RA collision avoidance alert information, whereas current ADS-B does not contain collision avoidance alert information; (4) ADS-B may detect the aircraft information on the taxi way; this is to compensate for the secondary surveillance radar if TIS doesn't serve low airspace scanning; and (5) ADS-B mode S squitters may transmit 4 long messages including position, velocity, time and identity messages. TCAS may transmit 2 long messages, which are short of some information in comparison with ADS-B. TIS receives 1 massage each 15 seconds.

The rest of this invention will be readily apparent and further explained upon reference to the accompanying drawings, FIGS. 1 to 5, of the specification below:

FIG. 1 illustrates the flow chart of the robust data fusion procedure of multi-digital surveillance information that fuses ADS-B, TCAS and TIS comprising the following steps:

Step one: get GNSS data 10 of the aircraft;

Step two: check whether aircraft received ADS-B data 11; if yes, go to step three 12; if no, go to step six 20;

Step three: check whether aircraft received TCAS data 12; if yes, go to step four 13; if no, go to step nine 23;

Step four: check whether aircraft received RA/TA data 13; if yes, go to step four 14; if no, go to step eleven 25;

Step five: generate TCAS then output 14;

Step six: check whether aircraft received TCAS data 20; if yes, go to seven 21; if no, go to step thirteen 30;

Step seven: check whether aircraft received TIS data 21; if yes, go to step eight 22; if no, go to step fourteen 31;

Step eight: fuse TCAS and TIS data then output 22;

Step nine: check whether aircraft received TIS data 23; if yes, go to step ten 24; if no, go to step fifteen 32;

Step ten: fuse ADSB and TIS data then output 24;

Step eleven: check whether aircraft received TIS data 25; if yes, go to step twelve 26; if no, go to step sixteen 33;

Step twelve: fuse ADSB, TIS and TCAS data then output 26;

Step thirteen: generate TIS then output 30;

Step fourteen: generate TCAS then output 31;

Step fifteen: generate ADSB then output 32; and

Step sixteen: fuse ADSB and TCAS data then output 33.

FIG. 2 illustrates flow chart fusing ADS-B and TIS comprising the following steps:

Step one: fuse ADSB and TIS data 10, then go to step two 11; and

Step two: get relative altitude, relative distance and vertical identification data generated by TIS 11, then go to step three 12.

Step three: get the rest of the data from ADSB, then output 13.

FIG. 3 illustrates the flow chart fusing ADS-B and TCAS comprising the following steps:

Step one: fuse ADSB and TCAS data 10, then go to step two 11;

Step two: check whether aircraft gets RA/TA data 11; if yes, go to step three 12; if no, go to step four 13;

Step three: get RA/TA data 12 then go to step four 13;

Step four: get relative altitude, relative distance, and velocity data generated by TCAS 13, then go to step five 14; and

Step five: get data from the ADSB 14 then outputs.

FIG. 4 illustrates the flow chart fusing TCAS and TIS comprising the following steps:

Step one: fuse TCAS and TIS data 10 then go to step two 11;

Step two: TCAS generates all information 11 and then outputs.

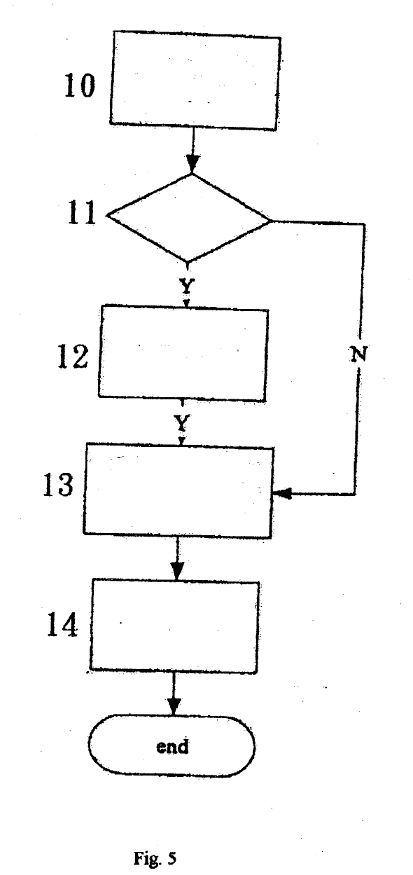

FIG. 5 illustrates the flow chart fusing ADS-B, TIS and TCAS comprising the following steps:

Step one: fuse ADSB, TIS and TCAS data 10, then go to step two 11;

Step two: check whether aircraft received RA/TA data 11; if yes, go to step three 12; if no, go to step four 13;

Step three: get RA/TA data 12 then go to step four 13;

Step four: get relative distance, altitude and velocity data generated by TCAS 13, then go to step five 14; and

Step five: ADSB receives the rest of data 14, then outputs.

Various modifications of the embodiments specifically illustrated and described herein will be apparent to those skilled in the art in light of the teaching of this invention. The invention should not be construed as limited to the specific form and examples as shown and described, but instead is set forth the following claims.

What is claimed is:

1. A robust data fusion procedure of multi-digital surveillance information, wherein said procedure is applied to fuse data provided by surveillance sources (ADSB, TCAS and TIS) and traffic information, provided by GNSS, of an aircraft, and to output the status information of other aircrafts in surrounding airspace to a cockpit display of traffic information (CDTI) system.

2. The robust data fusion procedure of multi-digital surveillance information as in claim 1, wherein said procedure of fusing ADSB, TCAS and TIS comprises the steps of:
(a) Step one: get GNSS data 10 of the aircraft;
(b) Step two: check whether aircraft received ADS-B data 11; if yes, go to step three 12; if no, go to step six 20;
(c) Step three: check whether aircraft received TCAS data 12; if yes, go to step four 13; if no, go to step nine 23;
(d) Step four: check whether aircraft received RA/TA data 13; if yes, go to step four 14; if no, go to step eleven 25;
(e) Step five: generate TCAS then output 14;
(f) Step six: check whether aircraft received TCAS data 20; if yes, go to seven 21; if no, go to step thirteen 30;
(e) Step seven: check whether aircraft received TIS data 21; if yes, go to step eight 22; if no, go to step fourteen 31;
(g) Step eight: fuse TCAS and TIS data then output 22;
(h) Step nine: check whether aircraft received TIS data 23; if yes, go to step ten 24; if no, go to step fifteen 32;
(i) Step ten: fuse ADSB and TIS data then output 24;
(j) Step eleven: check whether aircraft received TIS data 25; if yes, go to step twelve 26; if no, go to step sixteen 33;
(k) Step twelve: fuse ADSB, TIS and TCAS data then output 26;
(l) Step thirteen: generate TIS then output 30;
(m) Step fourteen: generate TCAS then output 31;
(n) Step fifteen: generate ADSB then output 32; and
(o) Step sixteen: fuse ADSB and TCAS data then output 33.

3. The robust data fusion procedure of multi-digital surveillance information as in claim 1, wherein said procedure of fusing ADSB and TIS further comprises the steps of:
(a) Step one: fuse ADSB and TIS data 10, then go to step two 11;
(b) Step two: get relative altitude, relative distance and vertical identification data generated by TIS 11, then go to step three 12; and
(c) Step three: get the rest of data from ADSB, then output 13.

4. The robust data fusion procedure of multi-digital surveillance information as in claim 1, wherein said procedure of fusing ADSB and TCAS further comprises the steps of:
(a) Step one: fuse ADSB and TCAS data 10, then go to step two 11;
(b) Step two: check whether aircraft gets RA/TA data 11; if yes, go to step three 12; if no, go to step four 13;
(c) Step three: gets RA/TA data 12 then go to step four 13;
(d) Step four: get relative altitude, relative distance, and velocity data generated by TCAS 13, then go to step five 14; and
(e) Step five: get data from the ADSB 14 then outputs.

5. The robust data fusion procedure of multi-digital surveillance information as in claim 1, wherein said procedure of fusing TCAS and TIS further comprises steps:
(a) Step one: fuse TCAS and TIS data 10 then go to step two 11;
(b) Step two: TCAS generates all information 11 and then outputs.

6. The robust data fusion procedure of multi-digital surveillance information as in claim 1, wherein said procedure of fusing ADS-B, TIS and TCAS further comprises the steps of:
(a) Step one: fuse ADSB, TIS and TCAS data 10, then go to step two 11;
(b) Step two: check whether aircraft received RA/TA data 11; if yes, go to step three 12; if no, go to step four 13;
(c) Step three: get RA/TA data 12 then go to step four 13;
(d) Step four: get relative distance, altitude and velocity data generated by TCAS 13, then go to step five 14;
(e) Step five: ADSB gets the rest of data 14, then outputs.
